(19) United States
(12) Patent Application Publication
(10) Pub. No.: US 2002/0046351 A1
(43) Pub. Date: Apr. 18, 2002

(54) Intrusion preventing system

(76) Inventors: Keisuke Takemori, Saitama (JP); Toshiaki Tanaka, Saitama (JP); Kouji Nakao, Saitama (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/963,789

(22) Filed: Sep. 27, 2001

(30) Foreign Application Priority Data
Sep. 29, 2000 (JP) 2000-299555
Sep. 29, 2000 (JP) 2000-299556

(51) Int. Cl. G06F 12/14

(52) U.S. Cl. 713/201

(57) ABSTRACT

When an access from an intruder is detected, a destination rewriting section 441 of a converting section 44 rewrites a destination [regular] which has been registered in an access command [http . . . /regular/doc] to a directory [decoy] of a decoy region 42. A communication application 43 accesses the decoy region 42 designated by the access command. A response converting section 442 of the converting section 44 rewrites a response [success/decoy/doc] returned from the communication application 43 to the content [success/regular/doc] expressing a message where the access to the regular region 41 has been succeeded.

### BACKGROUND OF THE INVENTION

1. Field of the Invention

The present invention relates to an intrusion preventing system which prevents intruders from intruding a data terminal on a network to perform alteration, destruction or the like on the contents in the data terminal, and in particular to an intrusion preventing system which can securely prevent an intrusion without failure of the intrusion perceived by a intruder.

2. Description of the Related Art

In recent years, intrusion to an information-managing server for subversive activities represented by alteration of a homepage goes on. In order to solve such a problem, such a measure is employed that a communication session of an intruder is prevented from intruding or entering in an information-managing server. For example, such a method is employed that a route which is easy to attack is blocked by closing unnecessary ports of a server, a communication session of an intruder is filtered by providing a firewall, or a communication session of an intruder is disconnected.

In the above conventional access preventing systems, since an intruders can perceive failure of the intrusion, there has been a case that the intruders try to illegally access a server again by anther access method, or they change the target to a subversive activity or an obstruction activity such as concentrating a large number of communication sessions on the server to cause server down.

In order to solve such a technical problem, there has been proposed a technique that a decoy server which is easy to access is intentionally arranged in the vicinity of an original or primary server and an intrusion to the original server is prevented by allowing alteration of the decoy server, and failure of the intrusion is prevented from being perceived by an intruder (CyberCop Sting available from Network Associates Corp. USA).

In the above-mentioned conventional art, such a configuration is employed that a decoy function is installed in a server to create a virtual network or a decoy server and communication setting to this virtual decoy server or the like is made easier than that to the original server so that an intruder is lured to the decoy servers.

There has been a possibility that, since such a decoy server created by the decoy function or the like is delicately different in behavior from the original server, the decoy server is detected or recognized. For this reason, there is a problem that, when a regular or original server is attacked again, the server is intruded like the conventional art.

### SUMMARY OF THE INVENTION

An object of the present invention is to provide an intrusion preventing system which prevents an intrusion to the original server and blocks an intruder to perceive failure of the intrusion. In order to achieve the above object, an intrusion preventing system of the present invention which prevents intrusion to regular data storage means connected to a network, comprises: decoy data storage means which is provided separately from the regular data storage means; and guiding means which guides an intrusion directed to the regular data storage means to the decoy data storage means.

Accordingly, even when a regular region of the regular data storage means is attacked by intruders, intruding region can be changed secretly for a decoy region so that the regular region can be protected from an intrusion or invasion.

### BRIEF DESCRIPTION OF THE DRAWINGS

FIG. 1 is a block diagram showing a configuration of a network to which an intrusion preventing system of the present invention is applied;

FIG. 2 is a block diagram of a first embodiment;

FIG. 3 is a diagram showing a communication sequence at a time of access effected by an innocent user;

FIG. 4 is a diagram showing a communication sequence at a time of access effected by an intruder;

FIG. 5 is a block diagram of a modification of the first embodiment;

FIG. 6 is a block diagram of a second embodiment of a server 2;

Fig. 7 is a block diagram of a third embodiment of a server 2;

FIG. 8 is a block diagram of a fourth embodiment of a server 2;

FIG. 9 is a diagram showing a communication sequence at a time of access effected by an innocent user;

FIG. 10 is a block diagram of a fifth embodiment;

FIG. 11 is a diagram showing a flow of a packet before an intrusion is detected;

FIG. 12 is a diagram showing a flow of the packet after the intrusion has been detected; and

FIGS. 13, 14 and 15 are diagrams showing one example of a communication sequence.

### DETAILED DESCRIPTION OF THE PREFERRED EMBODIMENTS

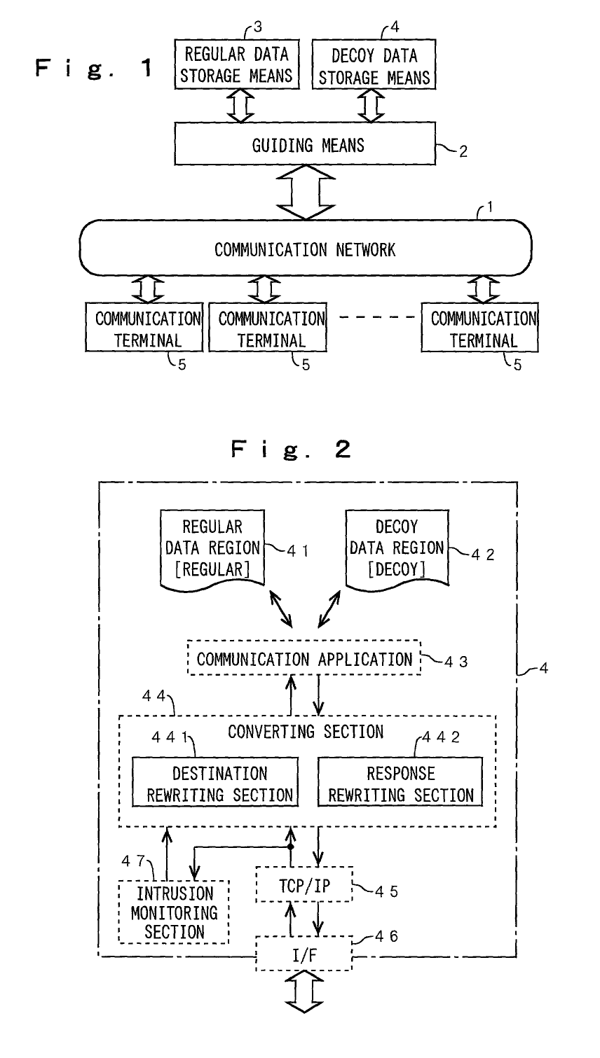

FIG. 1 is a block diagram showing a configuration of a communication network to which an intrusion preventing system of the present invention is applied. In a communication network 1, regular data storage means 3 to be protected from an intrusion by an illegal access utilizing a communication terminal 5 and decoy data storage means which allows illegal access to the regular data storage means 3 in place of the regular data storage means 3 are connected to each other via guiding means 2. The guiding means 2 guides an illegal access to the regular data storage means 3 to the decoy data storage means 4.

FIG. 2 is a block diagram of a first embodiment of an intrusion preventing system, where a regular region 41 and a decoy region 42 are secured in different storage regions on one server 4. The regular region 41 and the decoy region 42 serves as the regular data storage means 2 and the decoy data storage means 3 which are controlled with the same IP address. A converting section 44 serves as the guiding means 2.

A network interface 46 controls a physical connection between the server 4 and the communication network 1. A TCP/IP section 45 executes a communication protocol on the basis of TCP/IP. When a password is set, an intrusion monitoring section 47 determines an access where the number of erroneously input passwords exceeds a predetermined value, an access which has performed a port scan, and the like as an access which has been illegally performed by an intruder. The monitor results are notified to the converting section 44. The converting section 44 includes a destination rewriting section 44 which rewrites a destination of an access command and a response rewriting section 442 which rewrites the content of a response command. The destination rewriting section 441 writes the destination of access command which has been determined as an illegal access by the monitoring section 47 to the decoy region 42. The response rewriting section 442 will be described latter.

A communication application 43 interprets an access command received from the converting section 44 in an application layer to access a data region (the regular region 41 or the decoy region 42) designated as a destination. The communication application 43 creates a response command to the access to return the same back to the response rewriting section 442. The response rewriting section 442 rewrites the response command indicating access to the decoy region 42 to a response command indicating access to the regular region 41 to returned the rewritten command back to the TCP/IP section 45.

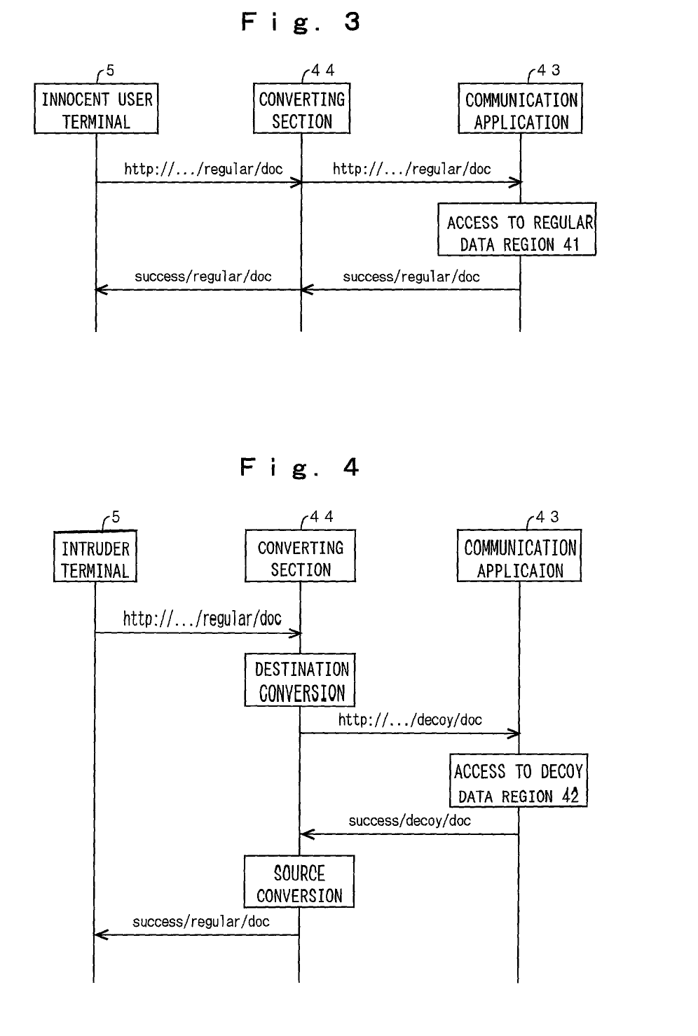

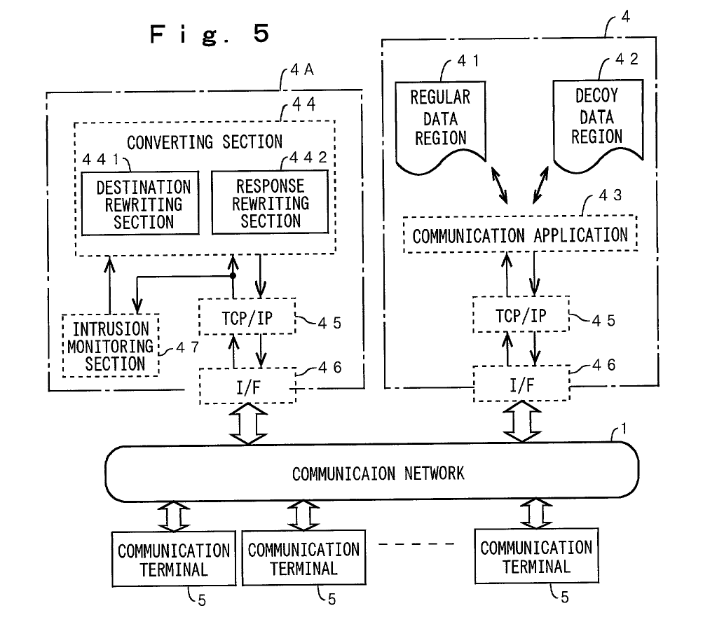

FIG. 3 shows a communication sequence conducted at a time of access of an innocent user. FIG. 4 shows a communication sequence conducted at a time of access of an intruder.

As shown in FIG. 3, when an innocent user inputs an access command [http. . . /regular/doc] designating an IP address of the server 2, a directory of the regular region 41 [regular], and a file name [doc], the access command is input into the converting section 44 of the server 2.

In the monitoring section 47 of the server 2, the access command is interpreted, and when the access command is not a command which has been issued by an intruder, such a fact is notified to the converting section 44. The converting section 44 transfers this access command to the communication application 43 without rewriting the command. The communication application 43 accesses the file [doc] of the directory [regular] which has been registered as a destination in the received access command.

When the communication application 43 succeeds in accessing, it creates a response command [success/regular/doc] to transfer it to the converting section 44. When the received response command relates to a regular region 41, the converting section 44 transfers this response command to the TCP/IP section 45 as it is, so that the response command is returned back to an innocent user terminal 5 via the communication network 1.

On the other hand, as shown in FIG. 4, when an access command is one from an intruder, such a fact is detected at the monitoring section 47 to be notified to the converting section 44. The destination rewriting section 41 of the converting section 44 rewrites directory [regular] designating the directory of the decoy region 41 contained in the access command [http. . . /regular/doc] to [decoy] designating the directory of the decoy region 42. Input into the communication application 43 is an access command [http. . . /decoy/doc]. The communication application 43 accesses the decoy region 42 designated by the directory [decoy] which has been registered in the access command. When succeeding in accessing, the communication application 43 creates a response command [success/decoy/doc] to return it back to the converting section 44. When the returned response command relates to the decoy region 42, the response rewriting section 442 of the converting section 44 rewrites [decoy] to [regular]. The response command is changed to [http. . . /regular/doc] so that it becomes the same as the response returned back to the innocent user 5 from the converting section 44 in FIG. 3. The intruders misunderstand that intrusion to the regular region 41 has been succeeded though they have intruded the decoy region 42.

According to this embodiment, since an intruder is allowed to intrude the decoy region 42 by rewriting the access command of the intruder, intrusion to the regular region 41 can be prevented. Since the intruders misunderstand that even though they have intruded in the decoy region 42, they have succeeded in intruding into the regular region 41, they maintain connection for a relatively long term. Therefore, it becomes possible to collect action logs or tracing data utilizing such a term. Since the intruder can not perceive failure of intruding the regular region 41, further intruding activities or other obstructing activities, subversive actions, troublesome activities or the like can be prevented from being conducted by the intruder.

In the above embodiment, the case that the converting section 44 and the monitoring section 47 are provided in the server 4 has been explained. As shown in Fig. 5, however, these sections 44 and 47 may be provided in an dedicated server 4A different from the server 4. Regarding the access command from the intruder, its content is converted in a converting section 44 in the dedicated server 4A and access is conducted to the decoy region 42 in the server 4. The converting section 44 and the monitoring section 47 may individually be connected between the communication network 1 and the server 4.

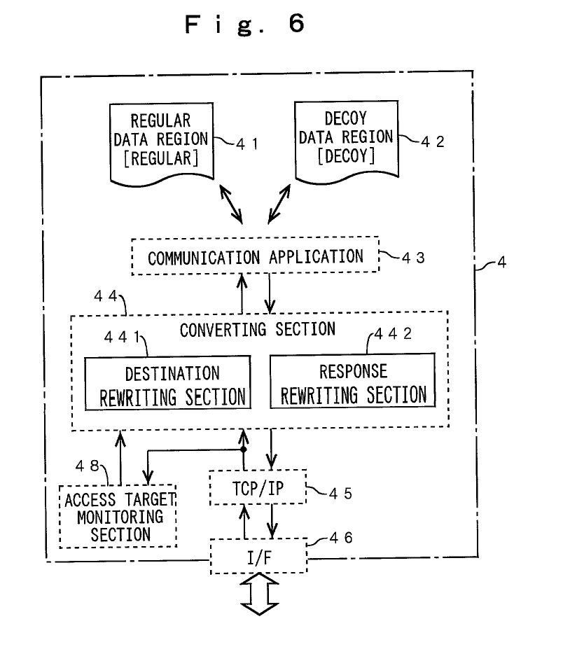

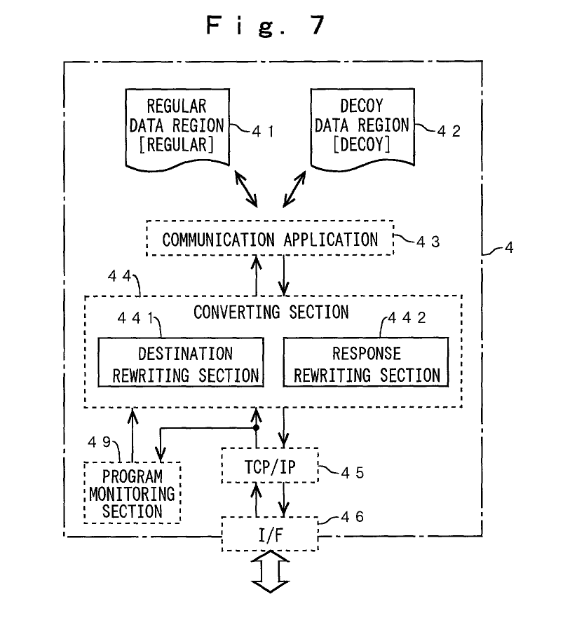

FIG. 6 is a block diagram of a second embodiment, where an access target monitoring section 48 is provided instead of the monitoring section 47. The access target monitoring section 48 regards all external access commands with destination of the regular region 41 as intrusions, so that the directory [regular] which is the destination is rewritten to the directory [decoy] of the decoy region 42. According to this embodiment, an intrusion to the regular region 41 to which an external access is not allowed can securely be prevented by a simple configuration.

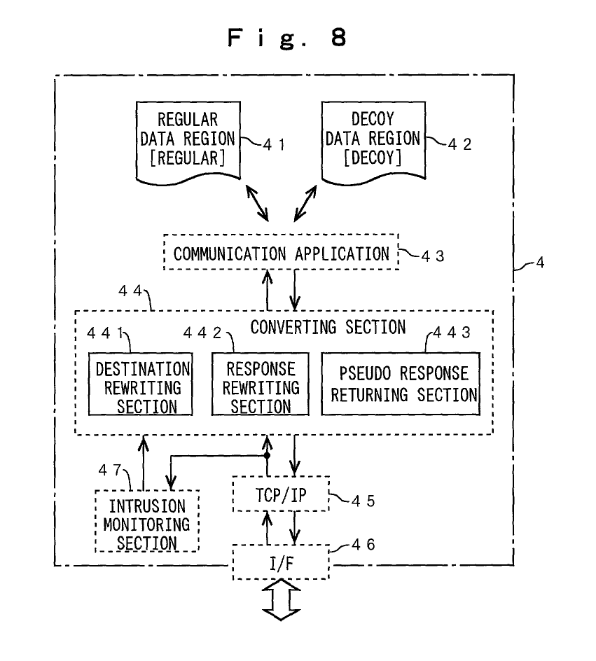

FIG. 7 is a block diagram of a third embodiment. Only browsing data stored in the regular region 41 can be allowed through a homepage opened to the public but only subversive activities such as alternation must be prevented.

This embodiment is provided with a program monitoring section 49 instead of the access target section 48. The program monitoring section 49 monitors a program included in an access command and when it detects that the access command includes a program inherent to an illegal access, it regards this command as an access command of an intruder. For example, in ftp (file transfer protocol), when the program is rm (erasure), put (substitution with other data) or the like, this access is regarded as an illegal access so that the destination of the access is rewritten to the decoy region 42.

According to this embodiment, only subversive activities such as alternation or erasure of the contents of the regular region 41, substitution (copying or transfer) with other data are prevented but only browsing of the regular region 41 is allowed, so that both browsing of the regular region 41 conducted by an innocent user and prevention of subversive activities effected by an intruder can be achieved.

In each of the above embodiments, such a configuration has been employed that the monitoring section 47 (the first embodiment), the access target monitoring section 48 (the second embodiment), or the program monitoring section 49 (the third embodiment) is provided so as to judge the contents of an access command and a determination is made on the basis of the judgment results whether or not the access command should be rewritten. In this invention, such a configuration can be employed that all access commands whose IP addresses are the server 4, namely all access commands directed to the server 4, are rewritten such that their destinations are directed to the decoy region.

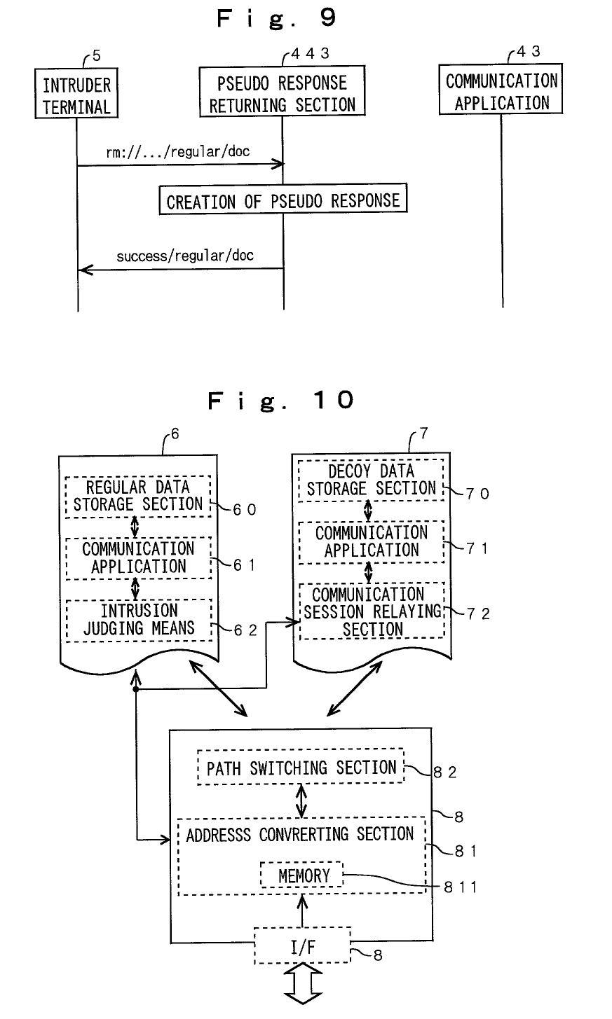

FIG. 8 is a block diagram of a fourth embodiment. In each of the above embodiments, all the access commands from the intruders are transferred to the decoy region 42. However, it is desirable that an access command including a risky command which may destroy the function of the decoy region 42 is prevented from intruding even the decoy region 42. In this embodiment, the access command including a risky program which may destroy the function of the decoy region 42 is not transferred to the decoy region 42, but creation/returning of a pseudo response is performed in a pseudo response returning section 443 of the converting section 44 to conduct a pseudo response.

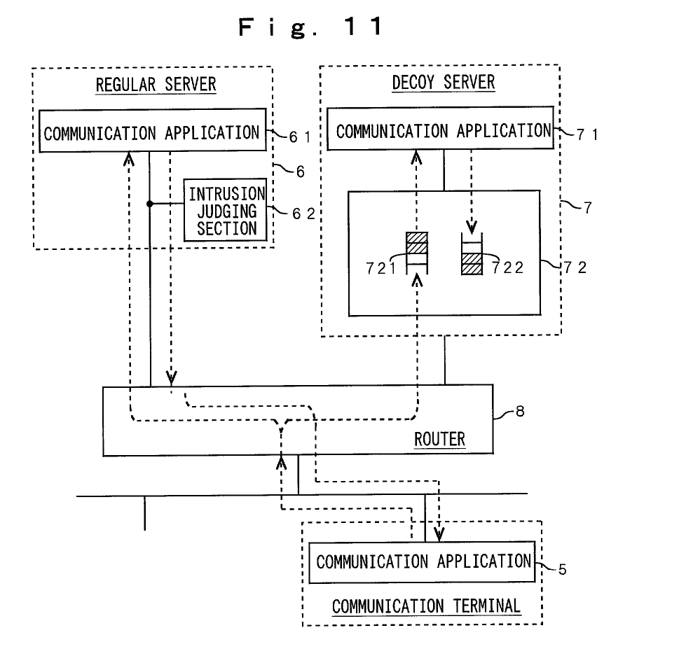

FIG. 9 shows a communication sequence at a time of access conducted by an intruder in the fourth embodiment. The access command [rm (erasure). . . /regular/doc] from the intruder is detected in the monitoring section 47 and it is notified to the pseudo response returning section 443. The pseudo response returning section 443 does not transfer the access command to the communication application 43 but it creates a response command [success/regular/doc] to return it back. The intruder misunderstands that the intrusion to the regular region 41 has been succeeded though he/she could not access the regular region 41. Therefore, re-intruding activities, obstructive activities or subversive activities effected by an intruder can be prevented.

In each of the above-mentioned embodiments, the case that the intrusion is detected in the application layer has been explained. Regarding packets exchanged in the a TCP/IP layer, such a configuration can also be employed that as regards a large number of IP packets where a source and a destination are the same, or packets including data attached with bag of OS or the like, such packets are regarded as packets for intrusion to be guided to the decoy region 42.

FIG. 10 is a block diagram of a fifth embodiment. In the first to fourth embodiments, the regular region 41 and the decoy region 42 maintained in different storage regions on the same or one server 4 respectively serve as the regular data storage means 2 and the decoy data storage means 3 shown in FIG. 1, and the server 4 also functions as the guiding means 2.

In the fifth embodiment, a regular server 6 and a decoy server 7 provided together with the regular server 6 functions as the regular data storage means 2 and the decoy data storage means 3. A router 8 functions as the guiding means 2.

In the router 8, a network interface 80 controls a physical connection between the router 8 and the communication network 1. An address converting section 81 is provided with, for example, a NAT (Network Address Translator), where address information of input/output packets is rewritten on the basis of address corresponding information which has been stored in a memory 811. The address corresponding information which has been stored in the memory 811 is rewritten according to a rewriting instruction from an intrusion judging section 62 in a regular server 6 described later. A path switching section 82 transfers a received packet to the regular server 6, the decoy server 7 or the both on the basis of its destination.

In the regular server 6, regular data has been stored in a regular data storage section 60. A communication application 61 executes a command which has been registered in the received packet. When a password is set, the judging section 62 (for example, Real secure available from Internet Security System Inc. in USA) judges the access where the number of errors has exceeded a predetermined value, access where a port scanning has been conducted or the like as access of an intruder and such a judgment result is notified to the communication application 61, the router 8 and a communication session relaying section 72 described later.

In the decoy server 7, decoy data has been stored in its decoy data storage section 70. The communication application 71 executes a command which has been registered in the received packet in the same manner as the communication application 61 of the regular server 6. The relaying section 72 receives the communication session between the intruder and the regular server 6 to continue the same.

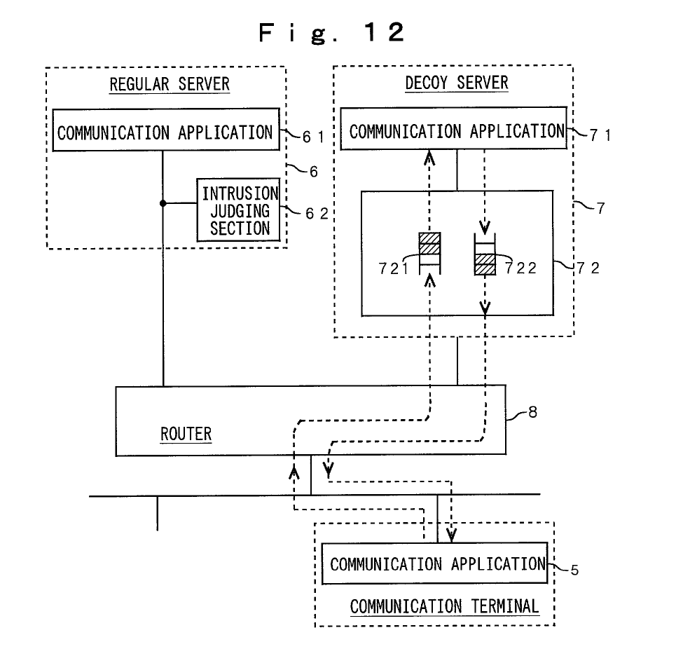

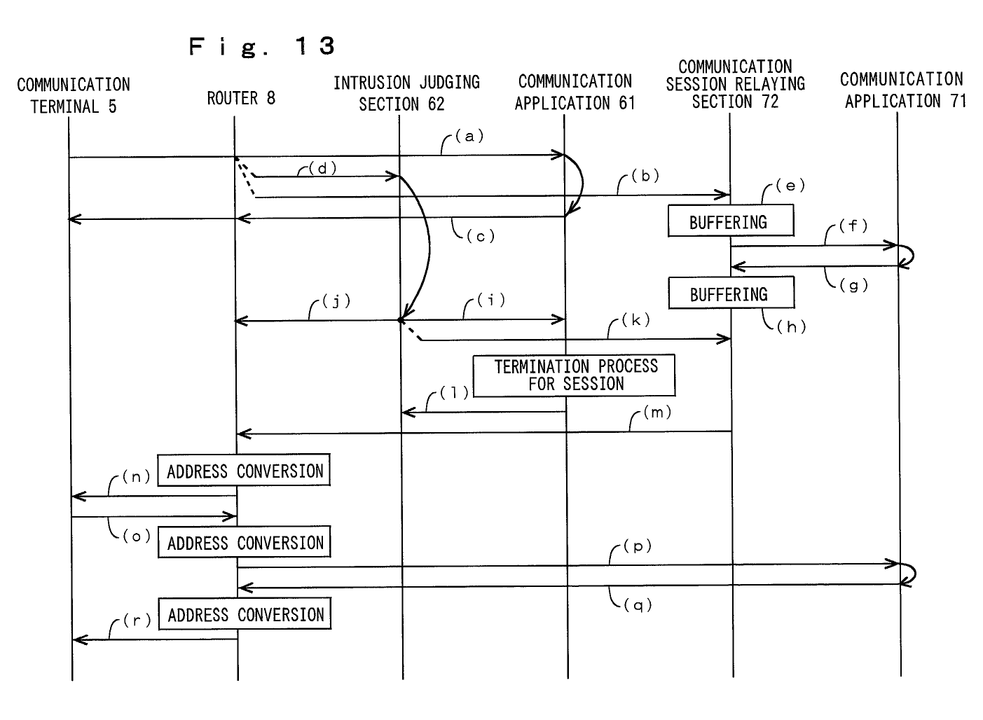

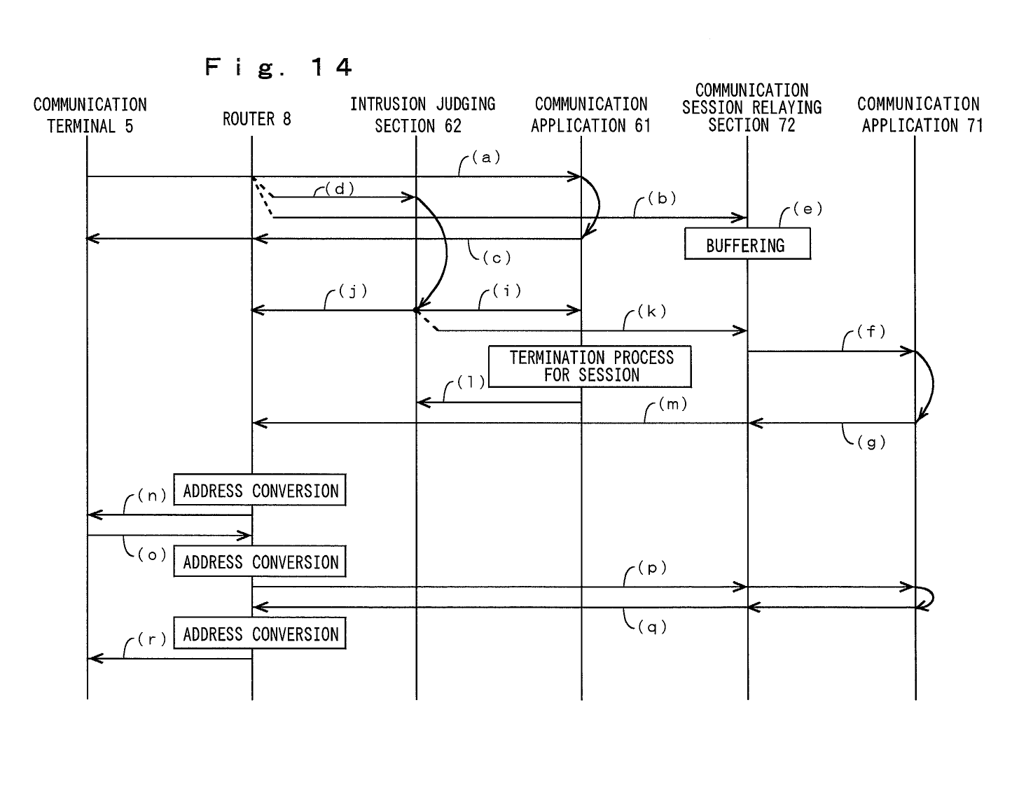

FIG. 11 shows a communication session of an innocent user or a communication session of an intruder until the session is judged as an intrusion. FIG. 12 shows a communication session of the intruder after judgment has been made as the intrusion. FIG. 13 shows a communication sequence in a specification where the communication application 61 of the regular server 6 and the communication application 71 of the decoy server 7 operate in synchronism with each other.

As shown in FIG. 11, when the innocent user or the intruder transmits a packet towards the regular server 6, the path switching section 82 of the router 8 transfers the received packet towards both the regular server 6 and the decoy server 7 [procedures (a), (b) in FIG. 13]. The judging section 62 monitors the received packet [procedure (d)] to judge whether or not the user of the communication terminal 5 is an intruder.

In the regular server 6, the communication application 61 receives a packet to establish a communication session between the same and the communication terminal 5. The communication application 61 executes a command which has been registered in the received packet to return a response command back [procedure (d)]. This response command is returned back to the communication terminal 5 of the user.

In parallel to this procedure, the received packet is stored [procedure (e)] in a buffer 721 for transfer in the relaying section 72 of the decoy server 7, and it is transferred to the communication application 71 [procedure (f) ]. The communication application 71 executes a command which has been registered in the received packet to create a response command thereto and return it back to the relaying section 72 [procedure (g)]. This response command is stored in a buffer for return 722 [procedure (h)], but it is not returned back to the router 8 at this time. When the communication session is from an innocent user and an intrusion is not detected by the judging section 62, the respective processings are repeated.

When a communication session is from an intruder and this fact is detected by the judging section 62, a command for terminating the communication application is notified to the communication application 61 [procedure (i)]. A message indicating detection of an intrusion is notified to the router 8 and the relaying section 72 [procedures (j), (k)]. The communication application 61 of the regular server 6 terminates the communication session during execution in response to the notification, and a message showing the termination is notified to the judging section 62 [procedure (1)]. The relaying section 72 receives a message describing detection of the intrusion from the judging section 62 together with the packet number of the first packet which has been judged as the intrusion. As shown in FIG. 12, the relaying section 72 outputs response commands which have been stored in the buffer for return 722 to the router 8 in the order of corresponding to the packet number [procedure (m)].

In this embodiment, since the response commands to an intruder can sequentially be output from the first packet which has been judged as an intruder, the communication session between the intruder and the regular server 6 can normally be relayed to the decoy server 7.

In the router 8, an address converting section 81 rewrites the contents of the response command output from the buffer for return 722 to the contents of a response command which will be output when the regular server 6 receives a packet to return it [procedure (n)]. That is, the source address of the response command is converted from the address of the decoy server 7 to the address of the regular server 6, and the response command is converted to a message indicating success of access to the regular server 6. Accordingly, since the intruder receives the response command indicating that the source address is the regular server, the user does not perceive that he/she has failed in intrusion to the regular server 6.

In the following procedures, all destination addresses of packets output from the communication terminal 5 within the communication session are rewritten to address of the decoy server 7 in the address converting section 81 [procedure (o)]. Therefore, all packets transmitted from the communication terminal 5 towards the regular server 6 are transferred to the decoy server 7 [procedure (p)]. Since the source addresses of response commands returned back from the decoy server 7 [procedure (q)] are rewritten to the address of the regular server 6 in the address converting section 81 to output the response commands [procedure (r) ], the failure of intrusion to the regular server 6 is prevented from being perceived by the intruder.

According to this embodiment, since the packets received in the communication session which has been judged as the intrusion are rewritten from the address of the regular server 6 to the decoy server 7, the intrusion to the regular server 6 can be prevented. Also, since the intruder misunderstands that he/she has succeeded in intrusion into the regular server 6 though he/she has intruded the decoy server 7 and maintains the connection to the decoy server 7, it becomes possible to collect action logs or tracing data during his/her misunderstanding. Furthermore, since the intruder can not perceive his/her failure of the intrusion to the regular server 6, re-intruding activities or other obstructive activities, subversive activities and/or troublesome activities of the intruder can be prevented.

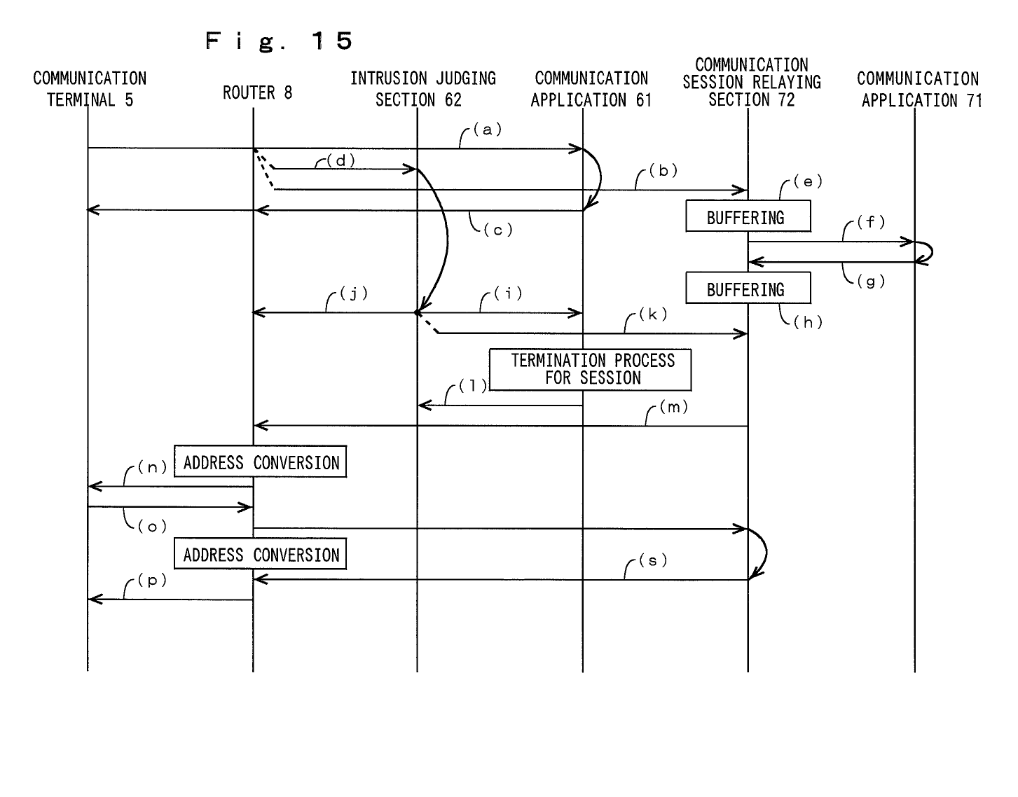

FIG. 14 shows a communication sequence in the specification where the communication application 61 of the regular server 6 and the decoy server 7 operated in a synchronous manner.

The decoy server 7 read a packet to execute a command after an intrusion is detected in the judging section 62.

As shown in FIG. 11, when the innocent user or the intruder transmits a packet towards the regular server 6, the path switching section 82 of the router 8 transfers the received packet towards both the regular server 6 and the decoy server 7 [procedures (a), (b) in FIG. 14]. The judging section 62 monitors the received packet [procedure (d)] to judge whether or not the user of the communication terminal 5 is an intruder.

In the regular server 6, the communication application 61 receives a packet to establish a communication session between the same and the communication terminal 5. The communication application 61 executes a command which has been registered in the received packet to return a response command back [procedure (d)]. This response command is returned back to the communication terminal 5 of the user.

In parallel with this processing, the received packet is stored [procedure (e)] in the buffer for transfer 721 in the relaying section 72 of the decoy server 7 but it is not transferred to the communication application 71. When the communication session is from an innocent user, the above-mentioned processings are repeated.

When a communication session is from an intruder and this fact is detected by the judging section 62, a command for terminating the communication application is notified to the communication application 61 [procedure (i)]. A message indicating detection of an intrusion is notified to the router 8 and the relaying section 72 [procedures (j), (k)]. The communication application 61 of the regular server 6 terminates the communication session during execution in response to the notification, and a message showing the termination is notified to the judging section 62 [procedure (1)]. The relaying section 72 receives a message describing detection of the intrusion from the judging section 62 together with the packet number of the first packet which has been judged as the intrusion.

The relaying section 72 transfers [procedure (f)] packets which have been buffered in the buffer for transfer 721 to the communication application 71 in the order of the packets corresponding to the packet numbers. The communication application 71 executes a command which has been registered in the received packet to create a response command thereto and return it back to the relaying section 72 [procedure (g)]. The response commands are transferred [procedure (m)] to the router 8 via the relaying section 72.

In the router 8, an address converting section 81 rewrites the contents of the response command output from the buffer for return 722 to the contents of a response command which will be output when the regular server 6 receives a packet to return it [procedure (n)].

In the following procedures, all destination addresses of packets output from the communication terminal 5 within the communication session are rewritten to address of the decoy server 7 in the address converting section 81 [procedure (o)]. Therefore, all packets transmitted from the communication terminal 5 towards the regular server 6 are transferred to the decoy server 7 [procedure (p)]. Since the source addresses of response commands returned back from the decoy server 7 [procedure (q)] are rewritten to the address of the regular server 6 in the address converting section 81 to output the response commands [procedure (r)], the failure of intrusion to the regular server 6 is prevented from being perceived by the intruder.

The judging section 62 and the relaying section 72 may be arranged at any places between the respective communication applications 61, 71 of the regular server 6 and the decoy server 7, and the communication network 1.

In the above embodiments, such a case has been explained that all the packets of the session which has been judged as the intrusion are transferred to the decoy server 7. However, it is desirable that such a packet including a risky command which may destroy the function of the decoy server 7 is prevented from intruding even the decoy server 7.

For this reason, as shown in FIG. 15, such a risky packet which may destroy the function of the server 7 is not transferred to the communication application 71, and the relaying section 72 creates/returns a response command to carry out a pseudo response [procedure (s)]. The address converting section 81 of the router 8 rewrites all source addresses to the address of the regular server 6 to output them [procedure (r)]. According to such a configuration, the decoy server can be protected from such risky illegal activities which may destroy its function.

In the above embodiments, suchacase has been explained that, for an access from the communication terminal 5, a communication session is first established between the regular server 6 and the communication terminal 5, and when an intrusion is detected, the communication session is relayed to the decoy server 7. However, such a configuration can be employed that all source addresses of the accesses which have been judged as intrusions are stored, and when access having the same source address is detected, its communication session is first established between the decoy server 7 and the user.

According to the present invention, the following effects can be achieved.

(1) Since an intruder is caused to intrude a decoy region by rewriting his/her access command, he/she is prevented from intruding a regular region.

(2) An intruder misunderstands that he/she has succeeded in intruding a regular region though he/she has intruded a decoy region, and he/she performs alteration or destruction of data in the decoy region. For this reason, since the intruder maintains connection to the decoy region for a relatively long term, it is made possible to collect action logs or tracing data during the term. As a result, it becomes possible to identify or specify the intruder.

(3) Since an intruder is prevented from perceiving his/her failure of intrusion to a regular region, re-intruding activities, or other obstructive activities, subversive activities of the same intruder can be prevented.

(4) When it is judged that a communication session established between a regular server and a communication terminal is due to an intrusion, the communication session is relayed to a decoy server, and all the subsequent packets to the regular server are transferred to the sever, so that the regular server can be protected from an intrusion.

(5) Since a risky command which may destroy the function of a decoy server is not transferred to a decoy server and a virtual response thereto is generated, the function of the decoy server can be prevented from being destroyed.

What is claimed is:

1. An intrusion preventing system which prevents an intrusion to regular data storage means connected to a network, comprising:
decoy data storage means which is provided separately from the regular data storage means; and
guiding means which guides an illegal access to the regular data storage means into the decoy data storage means.

2. An intrusion preventing system according to claim 1, wherein the regular data storage means and the decoy data storage means are respectively a regular region and a decoy region secured in different regions on the same server.

3. An intrusion preventing system according to claim 2, further comprising destination rewriting means which rewrites a destination of an access which is the server to the decoy region.

4. An intrusion preventing system according to claim 2, further comprising response rewriting means which rew rites the content of a response command returned in response to an access to the decoy region to the content of a response command which is to be returned in response to an access to the regular region.

5. An intrusion preventing system according to claim 3, further comprising illegal access monitoring means which monitors whether or not an access whose destination is the regular region is an illegal access, wherein
the destination rewriting means rewrites the destination of an illegal access to the decoy region.

6. An intrusion preventing system according to claim 3, further comprising access target monitoring means which monitors whether or not the destination of an access command is the regular region, wherein
the destination rewriting means rewrites the destination of an access command which is the regular region to the decoy region.

7. An intrusion preventing system according to claim 3, further comprising command monitoring means which monitors whether or not an access command includes a mala fide program which performs alteration or erasure of the content of the regular region, substitution of the content to other data, or the like, wherein
the destination rewriting means rewrites the destination of the access command including the mala fide program to the decoy region.

8. An intrusion preventing system according to claim 2, wherein the regular region and the decoy region are allocated with a common IP address.

9. An intrusion preventing system according to claim 2, further comprising means which collects action logs or trace data of a session guided to the decoy region.

10. An intrusion preventing system according to claim 1, wherein the regular data storage means is a regular server, and the decoy data storage means is a decoy server provided together with the regular server.

11. An intrusion preventing system according to claim 10, further comprising
intrusion judging means which judges whether or not a communication session established between the regular server and an external terminal is due to intrusion;
communication session relaying means which relays a communication session which has been judged as an intrusion from the regular server to the decoy server; and
path switching means which transfers a packet whose destination is the regular sever to the decoy server in a communication session which has been judged as the intrusion.

12. An intrusion preventing system according to claim 10, further comprising means which rewrites a response command returned from the decoy server into the content of a response command which is to be returned in response to an access to the regular server.

13. An intrusion preventing system according to claim 10, wherein the decoy server is a mirror server of the regular server.

14. An intrusion preventing system according to claim 11, wherein the communication session relaying means comprises
a buffer for transfer which sequentially transfers the same packets as packets whose destinations are the regular server to the decoy server; and
a buffer for return which sequentially stores responses returned from the decoy server in response to the transferred packets, wherein,
when the communication session which has been judged as the intrusion is relayed to the decoy server, the buffer for return sequentially outputs the responses from the first packet which has been returned in response to the first packet transferred after relayed.

15. An intrusion preventing system according to claim 11, wherein the communication session relaying means comprises
a buffer for transfer which sequentially stores the same packets as packets whose destinations are the regular server; and
a buffer for return which sequentially returns responses returned from the decoy server, wherein,
when the communication session which has been judged as the intrusion is relayed to the decoy server, the buffer for transfer sequentially outputs the responses from the first packet which has been returned in response to the first packet transferred after relayed.

16. An intrusion preventing system according to claim 11, further comprising pseudo response means which, without transferring a packet whose destination has been converted from the regular server to the decoy server, creates a response command to the packet in a pseudo manner to return the same.

17. An intrusion preventing system according to claim 11, wherein, when a source address of a communication session which has been judged as intrusion is stored and a packet containing the source address is then input, a communication session is established between the decoy server and the user.

18. An intrusion preventing system according to claim 11, wherein in the communication session established between the decoy server and the user, action logs and trace data of the user are collected.

19. An intrusion preventing system according to claim 11, wherein the path switching means includes means which converts the content of the response command returned from the decoy server to the content of a response command which will be output when the regular server receives a packet.

20. An intrusion preventing system which prevents an intrusion to a regular region of a server connected to a network, wherein
without allowing access to the regular region for an access command whose destination is the regular region, a pseudo response command expressing a message where the access to the regular region has been succeeded is returned response to the access to the regular region.
